(19) United States
(12) Patent Application Publication
(10) Pub. No.: US 2007/0217981 A1
(43) Pub. Date: Sep. 20, 2007

(54) PROCESSES AND SYSTEMS FOR THE SEQUESTRATION OF CARBON DIOXIDE UTILIZING EFFLUENT STREAMS

(76) Inventor: Dirk Thomas Van Essendelft, State College, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/686,619

(22) Filed: Mar. 15, 2007

Related U.S. Application Data
(60) Provisional application No. 60/786,937, filed on Mar. 29, 2006.
(60) Provisional application No. 60/782,392, filed on Mar. 15, 2006.

(51) Int. Cl. B01D 53/14

(52) U.S. Cl. 423/220

(57) ABSTRACT

Disclosed are processes and systems for sequestering carbon dioxide from a flue gas effluent from a parent process such as a coal-fired electric power plant. In one non-limiting embodiment of the invention, a mineral having a metal is dissolved with an acid to provide a solution having a predetermined pH. Carbon dioxide from the flue gas effluent and a base are added to the solution to provide a metal carbonate reaction to precipitate a metal carbonate, e.g., magnesium carbonate, from the solution. Heat, which may be supplied by the flue gas effluent, is used to power a base management system for recovering used base form the process.

### CROSS-REFERENCE TO RELATED APPLICATIONS

This application claims the benefit of U.S. Patent Application No. 60/780,392, “Process and Sequestration system for the Sequestration and Capture of Carbon Dioxide Utilizing Waste Heat from Effluent Streams”, filed Mar. 15, 2006, and U.S. Patent Application No. 60/786,937, “Process and Sequestration system for the Sequestration and Capture of Carbon Dioxide Utilizing Waste Heat from Effluent Streams”, filed Mar. 29, 2006. The entirety of each of these applications is incorporated by reference herein.

### FIELD OF THE INVENTION

The invention is in the field of sequestering carbon dioxide. The invention is also in the field of chemical process technology and systems useful in the commercial-scale synthesis of metal salts from mineral ores.

### BACKGROUND OF THE INVENTION

Fossil fuels have been a major source of energy in the United States for over a century. However, environmental standards regarding emissions of pollutants, e.g., greenhouse gases, especially carbon dioxide emissions from burning fossil fuels, into the air are becoming more stringent and, as a result, the processes and the equipment, e.g., furnaces, using fossil fuels are undergoing significant changes in order to accommodate these stricter standards. More particularly, the present management of carbon dioxide emissions, e.g., reduction of carbon dioxide emissions into the atmosphere, include (1) increasing the efficiency of energy conversion; (2) using a low-carbon or carbon-free energy source; and (3) capturing and sequestering carbon dioxide emissions. It is generally accepted that the first two alternatives provide only incremental improvements and, therefore technically sound, cost-effective carbon sequestration processes and sequestration systems are needed to approach zero transmission.

United States Patent Application Publication Number US 2005/0002847A1 discloses a process for sequestering carbon dioxide, which includes reacting a silicate-based material with an acid to form a suspension; combining the suspension with carbon dioxide to provide active carbonation of silicate-based material; producing a metal salt and silica; and regenerating the acid in the liquid phase of the suspension. It is appreciated by those skilled in the art that further improvements are needed to provide commercially-viable sequestration systems and processes. For example, improvements are needed in increasing the rate of mineral dissolution to further improve process efficiency. Additional improvements are needed in controlling the flow and minimizing the use of process chemicals, such as bases, for enabling commercially-viable solutions to the sequestration of carbon dioxide.

### SUMMARY OF THE INVENTION

In overcoming the challenges associated with improving the process for sequestering carbon dioxide, the present invention provides methods for sequestering carbon dioxide from a carbon dioxide-generating source, comprising: dissolving at least a portion of a mineral with an acid, the mineral comprising a metal or cations thereof, to provide an acidic mineral solution comprising metal cations and protons; contacting at least a portion of the metal cations with a base to give rise to a metal-containing solid precipitant and a supernatant; contacting flue gas from the carbon dioxide-generating source to at least a portion of the metal cations, or to at least a portion of the supernatant, or both, wherein the flue gas comprises carbon dioxide; and recovering base from the supernatant, wherein heat is utilized in recovering the base from the supernatant.

The present invention also provides methods for producing one or more substantially pure metal salts from a mineral, comprising: dissolving at least a portion of a mineral with an acid, the mineral comprising a metal or cations thereof, to provide an acidic mineral solution comprising metal cations and protons; contacting at least a portion of the metal cations with a base to give rise to a metal salt-containing solid precipitant and a supernatant; contacting flue gas from a carbon dioxide-generating source to at least a portion of the metal cations, or to at least a portion of the supernatant, or both, wherein the flue gas comprises carbon dioxide; and recovering base from the supernatant, wherein heat is utilized in recovering the base from the supernatant.

The present invention also provides a sequestration system for carrying out these processes. Accordingly, the present invention provides sequestration systems for sequestering carbon dioxide from a carbon dioxide-generating source, comprising: a mineral dissolving system for dissolving at least a portion of a mineral with an acid, wherein the mineral comprises metal or cations thereof, the mineral dissolving system capable of providing an acidic mineral solution comprising metal cations and protons; a metal salt precipitation system for contacting metal cations received from the mineral dissolving system with base to give rise to a metal salt-containing solid precipitant and a supernatant; a base management system for feeding base into the metal salt precipitation system and for recovering base from the supernatant; and a flue gas management system capable of: receiving at least a part of the flue gas comprising carbon dioxide from the carbon dioxide-generating source; contacting at least a portion of the flue gas to at least a portion of the metal cations, or to at least a portion of the supernatant, or both; and utilizing heat for recovering at least a portion of the base from the supernatant in the base management system.

In one embodiment, the invention also relates to sequestration systems for sequestering carbon dioxide, including a system for dissolving a mineral having a metal with an acid to provide a solution, having a predetermined pH; a feeder to add a base and carbon dioxide to the solution wherein the addition of the base and the carbon dioxide to the solution provides a metal carbonate reaction to precipitate a metal carbonate from the solution; an ammonium-based refrigeration process; at least one parent process generating a heated effluent and carbon dioxide and a connection between the parent process, the refrigeration process, and the feeder wherein heated effluent from the parent process fuels the ammonium-based refrigeration process, and the carbon dioxide is supplied to the feeder.

In another non-limiting embodiment of the invention, the sequestration system includes a precipitated salt production process. A connection between the parent process, the precipitated salt production process, and the feeder is provided, wherein heated effluent from the parent process fuels the precipitated salt production process, and the carbon dioxide is supplied to the feeder.

The invention further relates to a method of sequestering carbon dioxide. The method includes the steps of dissolving a mineral having a metal with an acid to provide a solution having a predetermined pH; adding a base and carbon dioxide to the solution to provide a metal carbonate reaction to precipitate a metal carbonate from the solution; providing an ammonium-based refrigeration process, and using heated effluent from a parent process to fuel the ammonium-based refrigeration process, and supply carbon dioxide to the metal carbonation reaction.

In another non-limiting embodiment of the invention, the method includes providing a precipitated salt production process, and using heated effluent from a parent process to fuel the salt production process, and supply carbon dioxide to the metal carbonation reaction.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 is a schematic of a non-limiting embodiment of a process for sequestration carbon dioxide;

FIG. 2 is a schematic of another non-limiting embodiment of a process for the sequestration of carbon dioxide;

FIG. 3 is a schematic of another non-limiting embodiment of a process for the sequestration of carbon dioxide;

FIG. 4 is a schematic of another non-limiting embodiment of a process for the sequestration of carbon dioxide;

FIG. 5A is a photograph of a suitable reactor for digesting minerals for use in a process for the sequestration of carbon dioxide;

FIG. 5B is a photograph of a suitable reactor system for digesting minerals for use in a process for the sequestration of carbon dioxide;

FIG. 6 depicts a graph plotting magnesium concentration vs. time for digesting serpentine at various conditions; and

FIG. 7 depicts a graph plotting extracted magnesium conversion vs. time for digesting serpentine at various conditions.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

As used herein, spatial or directional terms, such as “inner”, “outer”, “left”, “right”, “up”, “down”, “horizontal”, “vertical”, and the like, relate to the invention as it is shown in the drawing figures. However, it is to be understood, that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 6.7, or 3.2 to 8.1, or 5.5 to 10.

In the present invention, the methods for sequestering carbon dioxide from a carbon dioxide-generating source comprise several steps. One step includes dissolving at least a portion of a mineral with an acid, the mineral comprising a metal or cations thereof, to provide an acidic mineral solution comprising metal cations and protons. At least a portion of the metal cations are contacted with a base to give rise to a metal-containing solid precipitant and a supernatant. The base is recovered from the supernatant by using heat. In addition, flue gas from the carbon dioxide-generating source is contacted to at least a portion of the metal cations, or to at least a portion of the supernatant, or both, wherein the flue gas comprises carbon dioxide.

The processes can suitably be operated in which the acid type and its concentration in the acidic mineral solution are selected so as to ensure that the pH of the acidic mineral solution is less than about 4. Lower pH is often desirable, so that the pH of the acidic mineral solution can be less than about 3, or even less than about 2, or even less than about 1, or even less than about 0, or even less than about −1. Suitable acids include hydrochloric acid, sulfuric acid, nitric acid, carbonic acid, perchloric acid, chloric acid, hypochloric acid, acetic acid, phosphoric acid, or any combination thereof.

The mineral can be dissolved at almost any temperature suitable for the acid of choice, and more suitable dissolution temperatures are in the range of from about 25° C. to about the normal boiling temperature of the acid at atmospheric pressures. Accordingly, the upper dissolution temperature is suitably about 200° C., however, even higher temperatures are envisioned if elevated pressures are utilized. The mineral can be dissolved using autogenous grinding, non-autogenous grinding, no grinding, or any combination thereof. Grinding media can be used to aid the dissolution of the mineral. Suitable grinding media includes glass beads, silicon carbide beads, ceramic beads, steel beads, coated steel beads, or any combination thereof. Suitable grinding mills include rotary, rotary ball, rotary rod, vertical spindle mill, tower mills, and the like.

Oftentimes minerals contain undissolvable solids, such as silica, so that these undissolved solids can be removed from the mineral acid solution prior to further processing. Suitable methods for removing the undissolvable solids include filtration, hydro-cycloning, magnetic separation, or any combination thereof.

In one aspect of the methods, the metal ions and base can be contacted in one or more crystallizers, one or more reactive adsorption columns, or both, to form precipitants. In other aspects, precipitants can also be formed when flue gas and metal ions are contacted by bubbling the flue gas into the solution comprising the metal cations. A variety of other methods for contacting the flue gas with the solution include, but are not limited to, using a bubble tray tower, using a packed column, using a sparger, spraying the solution as a mist in a gaseous stream comprising the flue gas, using a stripper, utilizing a scrubber system, using a gas absorption column, or any combination thereof. Suitable scrubber systems that may be adapted for use to contact flue gas with the acidic mineral solution are described in U.S. Pat. No. 6,562,304, “Scubber for the Treatment of Flue Gases”, the entirety of which is incorporated by reference herein.

Precipitants suitably made according to the methods provided herein may comprise a solid oxide or hydroxide or salt of iron, magnesium, calcium, copper, manganese, chromium, sodium, or any combination thereof. In several preferred embodiments, as described herein, two or more different metal salts can be precipitated. In certain preferred embodiments, the preferred mineral is serpentine and the metal salts include iron oxide, iron hydroxide, and magnesium carbonate produced therefrom. The metal salts can be substantially pure made according the processes described herein, meaning that a particular precipitant, when dried, can contain in excess of 95 percent, or even in excess of 98 percent by weight of metal salt.

Suitable carbon dioxide generating sources include a hydrocarbon-fueled power system, a hydrocarbon-fueled engine for producing useful work, a chemical process system, a heating system, a cement kiln, a synthetic fuels generation system, or any combination thereof. Flue gas from the carbon dioxide generating source can be manipulated and controlled using any of a variety chemical processes. For example, the flue gas can be fluidically communicated into one or more of the following process units: a heat exchanger, a conduit for fluidically delivering the flue gas to a crystallizer, a reactive absorber, an absorber, a stripping column, a vapor-liquid continuously stirred tank reactor, a vapor-liquid plug flow reactor, vapor-liquid batch reactor, or a vapor-liquid semi-batch reactor.

Suitable minerals include olivine, serpentine, antigorite, basaltic formations, brucite, lizardite, cement, or any combination thereof. Suitable metals include iron, magnesium, calcium, copper, manganese, chromium, sodium, or combination thereof. Suitable metal cations include Fe+2, Fe+3, Mg+2, Mn+2, Cr+2, Cr+3, Na+, Zn+2, Al+3 or any combination thereof.

In carrying out one aspect of the method, the acid mineral solution and the base can be mixed in a first crystallizer to give rise to the metal-containing solid precipitant and a first supernatant. The pH of the contents in the first crystallizer can be suitably in the range of from about 5 to about 14, preferably in the range of from about 5 to about 9, and most preferably in the range of from about 6 to about 8. The first supernatant and a base can be mixed in a second crystallizer with the flue gas to give rise to a second metal-containing solid precipitant and a second supernatant. The pH of the contents in the second crystallizer can be suitably in the range of from about 6 to about 14, preferably from about 7 to about 11, and most preferably from about 8 to about 10. Alternatively, the first supernatant and a base can be mixed in an adsorption column or a reactive adsorption column with the flue gas to give rise to a second metal-containing solid precipitant and a second supernatant. In this alternative arrangement, positive metal ions can be exchanged with protons using a high pressure acid recycle loop in fluidic communication with ion exchange media. Suitable ion exchange media includes film, beads, resin, or any combination thereof.

Suitable bases used the methods described herein include ammonium hydroxide, sodium hydroxide, calcium hydroxide, potassium hydroxide, magnesium hydroxide, or any combination thereof. The process is configured so that the base can be removed from the supernatant. Suitable ways to remove the base from the supernatant include using an ammonium-based refrigeration system, an ion-exchange system, a crystallizer, one or more ion exchange membranes, a solar pond, an evaporative cooling tower, or any combination thereof.

Methods for utilizing flue gas containing carbon dioxide to prepare one or more substantially pure metal salts from a mineral are also provided. These methods include dissolving at least a portion of a mineral with an acid, the mineral comprising a metal or cations thereof, to provide an acidic mineral solution comprising metal cations and protons. At least a portion of the metal cations is contacted with a base to give rise to the one or more substantially pure metal salts and a supernatant. In these methods, the base is recovered from the supernatant using heat, which heat can be supplied from hot flue gas or another heat source, such as solar, electric, steam, chemical heat arising from an exothermic reaction, waste heat from another process, or any combination thereof. Flue gas from the carbon dioxide-generating source can also be contacted to at least a portion of the metal cations, or to at least a portion of the supernatant, or both, to give rise to one or more substantially pure metal salts. In addition to carbon dioxide, flue gas may also be composed of a variety of other gases composed of hydrogen, nitrogen, oxygen, sulfur, or carbon atoms, or any combination thereof. Such gasses include, but are not limited to, molecular nitrogen, molecular oxygen, carbon monoxide, nitrous oxide, sulfur dioxide, hydrocarbons, water, or any combination thereof.

Sequestration systems suitable for sequestering carbon dioxide from a carbon dioxide-generating source are also provided. These sequestration systems are also suitable for preparing one or more substantially pure metal salts from a mineral. Accordingly, suitable sequestration systems include a mineral dissolving system for dissolving at least a portion of a mineral with an acid, wherein the mineral comprises metal or cations thereof, the mineral dissolving system capable of providing an acidic mineral solution comprising metal cations and protons. A metal salt precipitation system can also be provided for contacting metal cations received from the mineral dissolving system with base to give rise to a metal salt-containing solid precipitant and a supernatant. The sequestration systems further include a base management system for feeding base into the metal salt precipitation system and for recovering base from the supernatant. The flue gas is controlled and manipulated using a flue gas management system, which is capable of receiving flue gas comprising carbon dioxide from the carbon dioxide-generating source; contacting at least a portion of the flue gas to at least a portion of the metal cations, or to at least a portion of the supernatant, or both; and utilizing heat for recovering at least a portion of the base from the supernatant in the base management system.

As described hereinabove, suitable carbon dioxide generating sources include a hydrocarbon-fueled power plant, a hydrocarbon-fueled engine for producing useful work, a chemical process factory, a heating system, a cement kiln, a synthetic fuels plant, or any combination thereof.

Suitable mineral dissolving systems include a reactor capable of contacting the mineral with the acid under autogenous grinding conditions, semiautogenous grinding conditions, non-grinding conditions, or any combination thereof. The mineral dissolving systems are capable of dissolving any type of mineral under acidic conditions. Suitable reactors may contain a grinding media to assist the dissolution of the minerals. Suitable grinding media include glass beads, silicon carbide beads, ceramic beads, steel beads, coated steel beads, steel rods, coated steel rods, or any combination thereof. The mineral dissolving systems are typically composed of or coated with an acid-resistant and abrasion-resistant material for withstanding attack from acids such as hydrochloric acid, sulfuric acid, nitric acid, carbonic acid, perchloric acid, chloric acid, hypochloric acid, acetic acid, phosphoric acid, or any combination thereof.

The sequestration systems are capable of handling any of a number of minerals such as olivine, serpentine, antigorite, basaltic formations, brucite, lizardite, cement, asbestos or any combination thereof. Accordingly, any of a number of metals or metal cations can be processed using the inventive sequestration systems. Suitable metals include, but are not limited to, iron, magnesium, calcium, manganese, chromium, sodium or any combination thereof. And suitable metal cations include, but are not limited to Fe+2, Fe+3, Mg+2, Mn+2, Cr+2, Cr+3, Na+, Zn+2, Al+3, or any combination thereof.

Suitable metal salt precipitation systems comprise a crystallizer capable of receiving acid mineral solution directly or indirectly from the mineral dissolving system, wherein the crystallizer can be further capable of receiving the base to give rise to the metal-containing solid precipitant and a supernatant. Additionally, the metal salt precipitation system may further comprise a second crystallizer capable of receiving acid mineral solution directly or indirectly from the supernatant arising from the first crystallizer, wherein the second crystallizer can be further capable of receiving a base and at least a portion of the flue gas to give rise to a second metal-containing solid precipitant and a supernatant. In other embodiments, the metal salt precipitation system may further comprise a reactive adsorption column capable of receiving acid mineral solution directly or indirectly from the supernatant arising from the first crystallizer, wherein the reactive adsorption column can be further capable of receiving a base and at least a portion of the flue gas to give rise to a second metal-containing solid precipitant and a supernatant. Alternatively, the metal salt precipitation system may further comprise a high pressure acid recycle loop in fluidic communication with ion exchange media capable of exchanging positive metal ions with protons.

Without being bound by any particular theory of operation, the cation exchange systems work primarily on one of two phenomena; the first being chelation, and the second being selective ion transport. Ion exchange resins are typically comprised of a single or branched polymer which is attached to a substrate on one end, such as silica. The free ends of the ion exchange resin contain a functional group that has a center of negative charge or from which protons can easily be removed (i.e., usually acidic groups). These groups are usually sulfites or amines. When these groups are exposed to a solution, a certain number of protons will leave the end functional group and enter solution. A cation is thus adsorbed to maintain charge balance. If the valence of the cation is +1 then the exchange is direct. However, if the valence is +2 or more, then an equal number of protons are desorbed from the surface. The size and charge density as well as the structure of the polymer and type of chelating group determine the affinity for one type of positive species over another. These resins can be applied to the surface of small beads, porous supports, tube walls, and can even be incorporated in gel form.

The second way to exchange ions is by selective ion transport. This process works by creating conditions within a membrane such that one species in a system will transport faster through the film than another. Most frequently, this kind of separation is a function of size and charge. A cation exchange membrane will likely block the transport of negatively charged species. This phenomenon occurs as a result of the cation exchange membrane containing functional groups (such as sulfites and amines) that have affinity for positive species, which affinity arises as a result of a localized negative molecular polarity. This localized negative polarity, in combination with size restrictions in pores, allows for cation motion of specific species and restricted motion of others. Thus, a chemical potential gradient of a cation species of interest from one side of a membrane to the other will result in transport of that particular ion through the membrane and restrict that of the others. This occurs even if there is an equal or potentially greater gradient for other species. Most suitable ion exchange membranes are a polymer type that function similarly to the cation exchange resins. Suitable ion exchange membranes are manufactured as a thin, porous, continuous plastic film rather than as small polymers applied to a surface. Various other types of porous ion exchange membranes, such as those made from ceramic, can be suitably used.

Another type of ion exchange film makes use of molecular baskets or molecular sieves. These are engineered molecular structures that have been purposefully designed and manufactured to fit a certain ion, atom, or molecule into its “basket” based on its size and shape. Suitable molecular sieves tend to have a very high selectivity for the ion, atom, or molecule for which they are designed. Membranes containing molecular sieves are suitably used as ion exchange membranes.

There are at least several ways to use cation exchange resins in the processes for removing base from the supernatant. The acid form of a resin is a resin that has its functional groups loaded with protons. The resin in this state can be dissolved in solution containing a particular metal cation of interest, e.g., magnesium. Based on the solution chemistry, pH, and activity of the resin, an equilibrium loading of metal cation on the resin will be attained. The highest loading of metal cation will occur at higher pH. However the affinity of the resin for metal cation plays a large role in the position of the equilibrium under any given circumstance. The resin can then be separated from that solution and exposed to an acidic solution with little or no metal cation. The equilibrium position under these conditions can be for no metal cation to be adsorbed and thus the resin is regenerated. This can be operated in a continuous fashion. This kind of ion exchange resin system is suitably used with gel type resins that can be pumped.

A second fashion is a semi-batch exchange column. In this embodiment, a column is packed with a resin on a substrate. The metal cation solution is pumped through the column in one direction. As the solution passes through the column, the metal cation is removed. When the column is loaded up with metal cation, the feed is cut off and a second feed is introduced in the opposite direction. The second feed consists of an acid with no metal cation and thus the metal cation is passed to the acid solution and the protons are adsorbed back onto the resin. This process can then be repeated. Several columns can be run in parallel so that the flow in the system need not be interrupted.

A membrane system can work in the same way. If there is a solution with high metal cation concentration on one side of a cation exchange membrane designed for the metal cation transport and a solution with no metal cation on the other side, metal cation will freely diffuse through the membrane to the low concentration side. Simultaneously, protons diffuse in the opposite direction. This is usually not a problem because protons are so small and also of positive charge. This can occur even if there is a significant pH difference between the solutions on either side of the membrane. However, the lower the pH of the acidic metal cation containing solution relative to the other solution, the faster this process will occur. For an industrial process, an apparatus can be designed to hold a membrane in place so that the solutions of interest are brought in contact on either side of the membrane. This is usually done in a counter flow arrangement and done so that many membranes can be run in parallel in a small volume.

The advantage of using a membrane system in the sequestration process is that the ions of interest can be moved without having to move water with them. This significantly reduces the amount of water that is needed to operate the process. Accordingly, this reduces thermal energy needs and increases the amount of carbon dioxide that can be captured with the same amount of low grade thermal energy.

Various sequestration systems contemplated by the invention also include one or more base management systems capable of controlling the flow of base within the sequestration system. Suitable bases are controlled by the base management system to precipitate the metal in the form of an oxide, a hydroxide or a salt, and to recover the supernatant using heat. Bases that can be used include ammonium hydroxide, sodium hydroxide, calcium hydroxide, potassium hydroxide, magnesium hydroxide, or any combination thereof. The oxides of all of these hydroxides are also powerful bases. Accordingly, the base management systems suitably include an ammonium-based refrigeration system, one or more ion-exchange systems, a crystallizer, one or more ion exchange membranes, or any combination thereof.

Various sequestration systems contemplated by the invention also include one or more flue gas management systems. Suitable flue gas management systems may include one or more of the following process components: a heat exchanger, a conduit for fluidically delivering the flue gas to a crystallizer, a reactive absorber, an absorber, a stripping column, a vapor-liquid continuously stirred tank reactor, a vapor-liquid plug flow reactor, vapor-liquid batch reactor, a vapor-liquid semi-batch reactor, or any combination thereof.

Before discussing non-limiting embodiments of the invention to sequester carbon dioxide from an effluent stream of a chemical or physical process that generates carbon dioxide, e.g., but not limiting to the invention, fossil fuel combustion, fossil fuel reformation, and chemical synthetic processes, it is understood that the invention is not limited in its application to the details of the particular non-limiting embodiments of the invention shown and discussed herein since the invention is capable of other embodiments. For example and not limiting to the invention, the sequestration system can be used to separate gases other than carbon dioxide, and/or to separate particles, from an effluent stream(s). Further, the terminology used herein to discuss the invention is for the purpose of description and is not of limitation. Still further, unless indicated otherwise in the following discussion, like numbers refer to like elements.

In the following discussion, several non-limiting embodiments of the invention pertaining to the reaction of aqueous Mg solutions with carbon dioxide are discussed using processes similar to that discussed in U.S. Pat. App. Pub. Nos. 2005/0002847A1 and 2005/0180910A1, the portion of each patent application publication pertaining to the reaction of metal solutions with carbon dioxide is incorporated by reference herein.

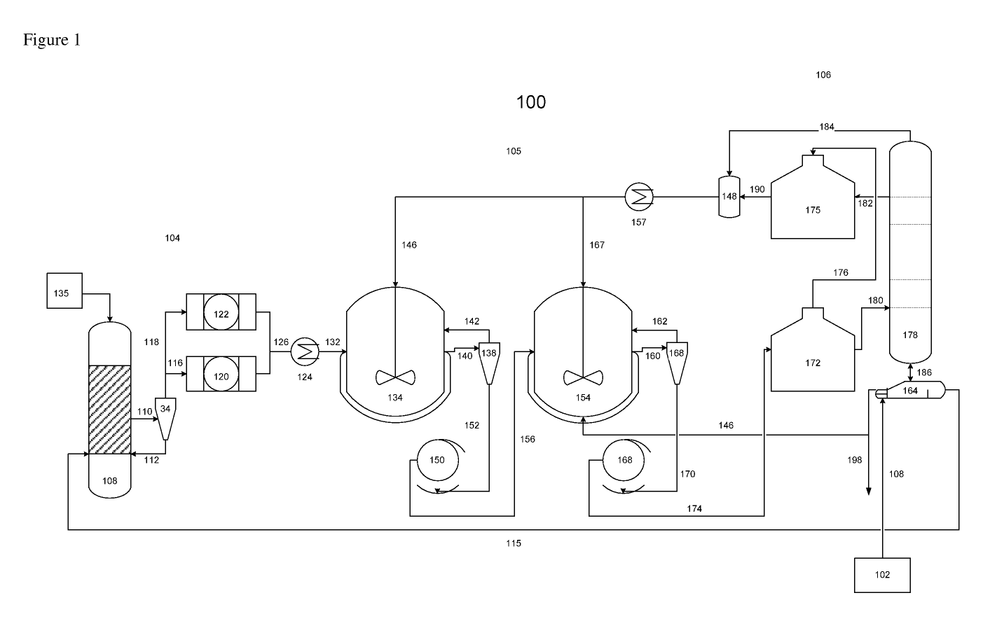

Shown in FIG. 1 is a non-limiting embodiment of a sequestration system 100 incorporating features of the invention to sequester and capture carbon dioxide from effluent streams from a parent process 102, e.g., a furnace, a reformer, and/or a chemical synthetic process, and utilizing heat from the effluent stream of the parent process 102 in the sequestration and capture of the carbon dioxide. As is appreciated by those skilled in the art, the invention is not limited to the temperature of the effluent stream low temperature waste heat. Suitable operating temperatures can be in the range of from about 50° C. to about 500° C., or even from about 100° C. to about 450° C., or even from about 150° C. to about 400° C., or even from about 200° C. to about 350° C.

The sequestration system 100, for ease of discussion and not limiting to the invention, includes three zones 104, 105, and 106. The first zone 104, in one non-limiting embodiment of the invention, includes a reactor 108 connected by outlet conduit 110 and by return conduit 112 to a hydro-cyclone 114, and connected to conduit 115 to move regenerated acid into the reactor 108; the hydro-cyclone 114 is connected by conduits 116 and 118 to filters 120 and 122, respectively; the filters 120 and 122 are connected to a first heat exchanger 124 by conduit 126, and a heat exchanger 124 is connected by conduit 132 to crystallizer 134 of the second zone 105.

In one non-limiting embodiment of the invention, particles that contain elements that can form carbonates, e.g., ultramafic minerals such as serpentine and olivine, any material containing magnesium, calcium, ferric iron, ferrous iron, aluminum, zinc, manganese, or any combination thereof, are fed into the reactor 108 in any convenient manner and dissolved or broken down, e.g., digested, in the reactor 108 by strong acids, such as but not limited to sulfuric acid, hydrochloric acid, or nitric acid, to free the elements, e.g., magnesium, calcium, ferric and ferrous iron, aluminum, zinc, and manganese, from the starting mineral/compounds. The acid is supplied to the reactor 108 from both an external supply 135 or from the zone 106 along the conduit 115. The reactor 108 includes a vertical spindle mill which provides energy for attrition grinding. Although attrition grinding is not necessary to digest the minerals, it serves to enhance the kinetics of the digestion, thereby improving the performance of the process. Without being bound by any particular theory of operation, it is believed that the grinding of the mineral particles during the digestion serves to refresh the particle surface and/or reduce particle size, such that diffusion or dissolved layers do not develop and slow the kinetics of the digestion. Portions of solution in the reactor having the grinding medium and the particles being digested is moved through the outlet conduit 110 to the hydro-cyclone 114. The hydro-cyclone 114 separates the grinding medium and large particles, e.g., in one non-limiting embodiment of the invention, particles equal to and greater than 10 microns from smaller particles or fines, e.g., in one non-limiting embodiment of the invention, less than 10 microns. The solution having the grinding medium and large particles is returned to the reactor 108 by the return conduit 112, and the solution having the smaller particles is moved through the conduits 116 and 118 to the filters 120 and 122. The filters 120 and 122 remove the small particles or fines from the solution, and the filtered solution is forwarded through a conduit 126 to the heat exchanger 124. The particles are indigestible material, e.g. silica from a starting mineral silicate.

As can be appreciated, the invention is not limited to the type or number of filters to remove particles from the solution. In one non-limiting embodiment of the invention, the filters 120 and 122 are press filters of the type used in the art to remove fine particles from a solution. As the collected fines or particles are removed from one filter, e.g., the filter 120, the other filter, e.g., the filter 122, is removing fines or particles from the solution. The collected fines can be substantially pure and/or sold. In one non-limiting embodiment of the invention, serpentine is the starting material and the fines from the filters 120 and 122 are pure or nearly pure silica.

The filtered solution moves through the heat exchanger 124 to reduce the temperature of the filtered solution to enhance crystallization of metals dissolved in the filtered solution. In one non-limiting embodiment of the invention, the temperature upstream of the heat exchange 124 is in the range of 80° C. to 110° C. and the temperature downstream of the heat exchanger 124 is in the range of 25° C. to 45° C. The reactor is operated at elevated temperatures to increase the digestion kinetics. As can be appreciated the heat exchanger 124 can be located between the hydro-cyclone 114 and the filters 120 and 122.

The chemistry and thermodynamics relating to the processes occurring in the processes provided herein are further described, in part, in U.S. Pat. App. Pub. Nos. 2005/0002847A1 and 2005/0180910A1, the portions of which are incorporated by reference herein.

The second zone 105 includes the first crystallizer 134 connected to the heat exchanger 124 of the first zone 104 by the conduit 132, connected to second hydro-cyclone 138 by outlet conduit 140 and return conduit 142, and connected by conduit 146 to a second heat exchanger 147, which is connected to mixing tank 148 by conduit 149; the second hydro-cyclone 138 is connected to a rotary filter 150 by conduit 152 and the rotary filter 150 connected to a second crystallizer 154 by conduit 156; the second crystallizer 156 connected to a third hydro-cyclone 158 by outlet conduit 160 and return conduit 162, connected to a boiler 164 of the third zone 106 by conduit 166, and connected to the heat exchanger 147 by conduit 167; the third hydro-cyclone 158 connected to a second rotary filter 168 by conduit 170, and the second rotary filter 168 connected to a first regeneration tank 172 of the third zone 106 of the sequestration system 100 by conduit 174.

In general, the second zone 105 of the sequestration system 100 is a pH swing system, i.e., changes the filtered solution from the heat exchanger 124 from a pH of less than 3 to a pH greater than 8 in a series of steps. More particularly, the acidic filtered solution from the heat exchanger 124 moves into the first crystallizer 134 through the conduit 132, and the solution in the crystallizer 134 changed from a pH below 3 to a pH in the range of 5-8 and, preferably, about 7, by the controlled addition of a base moving from the mixing tank 148 through the heat exchanger 147 into the crystallizer 134 through the conduit 146. In one non-limiting embodiment of the invention, the basic solution is ammonium hydroxide. At a pH of about 7, the transition metal hydroxides in the filtered solution will precipitate out of the solution. The solution from the first crystallizer 134 is moved through the conduit 140 to the second hydro-cyclone 138, where the solution having large particles is sent to the rotary filter 150 and, optionally, the solution having the smaller particles is returned by the conduit 142 to the first crystallizer 134 to ensure that there is solid available for seeding. The rotary filter 150 separates the particles from the solution and forwards the solution to the second crystallizer 154 through the conduit 156. The particles of transition metal hydroxides are removed from the rotary filter 150. In one non-limiting embodiment of the invention, the transition metal hydroxides are iron hydroxides that are impurities in the serpentine mineral ore. The particles removed from the first rotary filter 150 are generally pure, however, in the instance where a purer grade is needed, the particles can be substantially pure in any convenient manner.

The pH of the filtered solution in the crystallizer 154 is raised to a pH in the range of 8-10, e.g., about 9, with the addition of ammonium hydroxide from the mixing tank 148 through the heat exchanger 147 and through the conduit 167. The effluent stream from the boiler 164 is moved into the second crystallizer 154 through the conduit 166. As is known in the art, carbon dioxide readily dissolves at intermediate to high pH values without the need for high pressures, e.g., pressures above 1 atmosphere. In addition, mineral carbonates are insoluble at pH values above 7. These factors combine to yield a system in which mineral carbonate precipitates at a rate which is controlled by the induction of carbon dioxide into the mineral rich solution in the second crystallizer 154. Moderate pressures, e.g., between 1-3 atmospheres, can be used to increase this rate, however, it is not necessary for the overall conversion as the minerals can be recycled to the reactor 108 in the first zone 104 in a manner discussed below.

The solution from the second crystallizer 154 is moved through the conduit 160 to the third hydro-cyclone 158, where the solution having large particles of earth and/or rare earth metal carbonate, e.g., magnesium carbonate when serpentine or olivine minerals are used, is sent to the second rotary filter 168, and, optionally, the solution having the smaller particles is returned by the conduit 162 to the second crystallizer 154 to ensure there is solid available for seeding. The earth and/or rare earth metal carbonates are filtered from the solution by the rotary filter 168, and the filtered solution sent through the conduit 174 to the regeneration tank 172. The particles removed from the second rotary filter 168 are generally pure, however, in the instance where a purer grade is needed, the particles can be substantially pure in any convenient manner.

The invention is not limited to the components of the second zone discussed above and any crystallization system known in the art, preferably crystallization systems that separate relatively pure compounds from a solution can be used in the practice of the invention.

The third zone 106 of the sequestration system 100 is a reagent recovery system and/or an ammonium-based refrigeration system. In one non-limiting embodiment of the invention, the third zone 106 includes the first regeneration tank 172 connected to the second rotary filter 168 by the conduit 174. The first regeneration tank 172 is connected to a second regeneration tank 175 by conduit 176 and is also connected to distillation tower 178 by conduit 180; the distillation tower 178 is connected to the second regeneration tank 175 by conduit 182, to the mixing tank 148 by conduit 184 and to the boiler 164 by conduit 186, and the boiler 164 is connected to the waste gas output of the parent process 102 by conduit 188, and to the reactor 108 of the first zone 104 by the conduit 115. As is appreciated by those skilled in the art, the boiler 164 can be part of the tower 178 or separated from the tower and connected by a conduit, e.g., the conduit 186, for moving liquid to the boiler, vaporizing the liquid in the boiler, and moving the vapor to the distillation tower 178.

In one non-limiting embodiment of the invention, ammonium hydroxide is used as the base introduced into the crystallizers 134 and 154, and the solution from the second rotary filter 168 is loaded with ammonium. The first and second regeneration tanks 172 and 175, the distillation tower 178, the mixing tank 148, and the boiler 164 provide an ammonia refrigeration system that sends ammonium hydroxide to the crystallizers 134 and 154 and sulfuric acid to the reactor 108. More particularly, the solution from the second rotary filter 168 is moved through the conduit 174 into the regeneration tank 172. Because of a high concentration of ammonium in the solution in the first regeneration tank 172 and a low concentration of ammonium in the second regeneration tank 175, a high partial pressure of ammonia exists in the vapor region of the tank 172 and a low partial pressure of ammonia exists in the vapor region of the tank 175 moving ammonia from the tank 172 through the conduit 176 to the tank 175. This movement of the ammonia provides refrigeration, which can be used in the process or other processes. The concentration differences of the ammonium in the tanks 172 and 175 are maintained by the distillation of water and ammonia in the distillation tower 178, e.g. by forwarding water from the distillation tower 178 to the second regeneration tank 175 through the conduit 182. The feed for the distillation column 178 is the solution having a high ammonium concentration from the regeneration tank 172 through conduit 180. Weak ammonium hydroxide moves from the second regeneration tank 175 through the conduit 190 to the mixing tank 148 where it is mixed with ammonia vapor moving through the conduit 184 into the mixing tank 148 from the distillation tower 178 to provide a strong ammonium hydroxide solution, which is forwarded to the crystallizers 134 and 154 through the conduits 146 and 167, respectively, as discussed above.

In one non-limiting embodiment of the invention, the energy for the distillation of the ammonia and water in the distillation tower 178 is provided by the boiler 164. The heat to operate the boiler 164 is supplied by the heat from the effluent stream of the parent process moving through the conduit 188. In those instances, when the carbon dioxide in the effluent from the parent process is more than is needed to the steady state process, the cooled excess effluent is moved through the conduit 198 to the atmosphere or another process. Further, the invention contemplates adding heat to the system from a source other than the effluent stream from the parent process to sequester additional amounts, e.g., up to 100%, of carbon dioxide from the effluent stream.

As is appreciated, the invention is not limited to the system or process discussed above for the regeneration of the ammonium hydroxide and sulfuric acid, and any system or process to regenerate ammonium hydroxide can be used in the practice of the invention, e.g., ion exchange columns and ion exchange membranes.

In another non-limiting embodiment of the invention, a purge stream from the boiler 164 through conduit 192 is combined with a purge stream through conduit 194 from the tower 178 to make ammonium-based fertilizer.

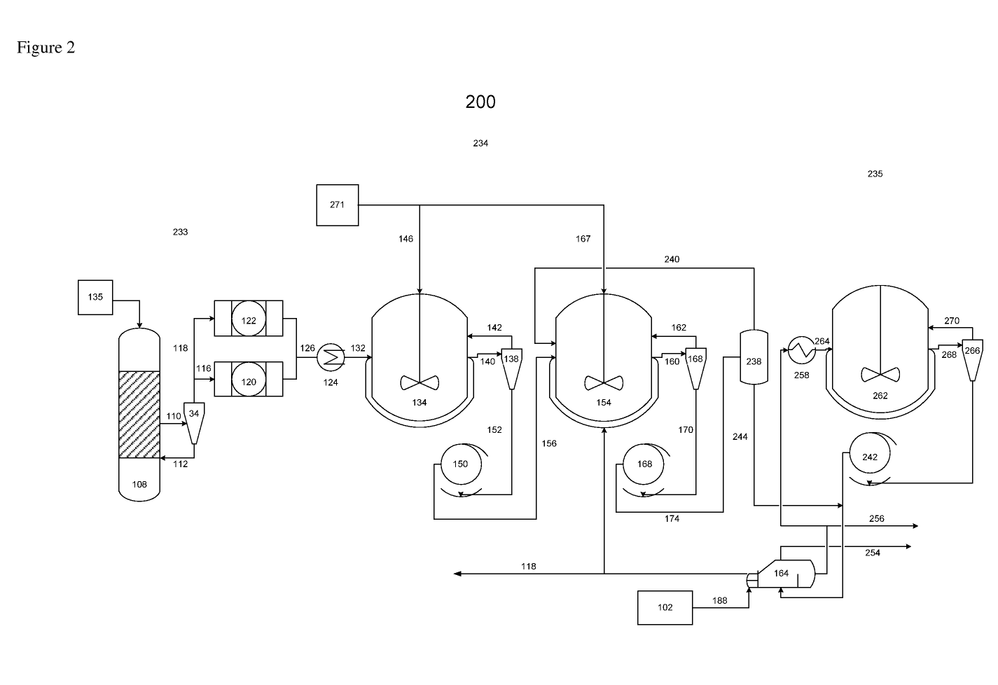

Shown in FIG. 2 is another non-limiting embodiment of the invention identified by the number 230. The sequestration system 230 includes first, second, and third zones 233, 234, and 235, respectively. The zones 233 and 234 are similar to the zones 104 and 105, with the differences discussed below.

The third zone 235 is a precipitated salt production process and includes but is not limited to a flash tank 238 connected to the second rotary filter 168 by the conduit 174, to the second crystallizer 154 by conduit 240; to a third rotary filter 242 through conduits 244 and 246; to the boiler 164 by the conduits 244 and 248; the boiler 164 connected to the third rotary filter 242 by the conduits 246 and 248, to the parent process 102 by the conduit 188, to the second crystallizer 154 by the conduit 166, to the atmosphere or other process(es) by the conduit 198, to a collector of steam (not shown) by conduit 254 to use as needed, to an aqueous ammonium purge 256, to a cooler 258 by conduit 260; the cooler 258 is connected to a third crystallizer 262 by conduit 264; the third crystallizer 262 is connected to a fourth hydro-cyclone 266 by outlet conduit 268 and inlet conduit 270; the hydro-cyclone 266 is connected to the third rotary filter 242 by conduit 269.

In one non-limiting embodiment of the invention, an ammonium source 271, preferably but not limited to anhydrous ammonia, is fed to the first and second crystallizers 134 and 154 through the conduits 146 and 167 to raise the pH of the solution in the first and second crystallizers 134 and 154. The solution from the second rotary filter 168 moves through the conduit 174 to the flash tank 238. Excess ammonia and carbon dioxide in the solution is removed and sent to the second crystallizer 154 through the conduit 240, and the solution sent to the boiler 164 through the conduits 244 and 248. Removing the excess ammonia and carbon dioxide from the solution and sending them back to the second crystallizer 154 can improve the yield of carbonated metal.

The boiler 164 in this embodiment of the invention functions to, among other things, concentrate the ammonium salt solution by removing water as steam. The concentrated solution is moved through the conduit 260 to the cooler 258. The solution is cooled to a temperature where the solution is thermodynamically suitable to precipitate ammonium salts, and the cooled solution moved through the conduit 264 into the third crystallizer 262. The operation of the third crystallizer 262, the fourth hydro-cyclone 266, and the third rotary filter 242 is similar to the operation of the second crystallizer 154, third hydro-cyclone 158, and the second rotary filter 168. The solids removed from the solution of the third crystallizer 262 by the rotary filter 242 includes ammonium-based fertilizer, e.g., ammonium sulfate, ammonium nitrate, ammonium chlorate depending on the acid used in the digestion system.

In another non-limiting embodiment of the invention, a liquid ammonium-based fertilizer is removed as a purge stream 256.

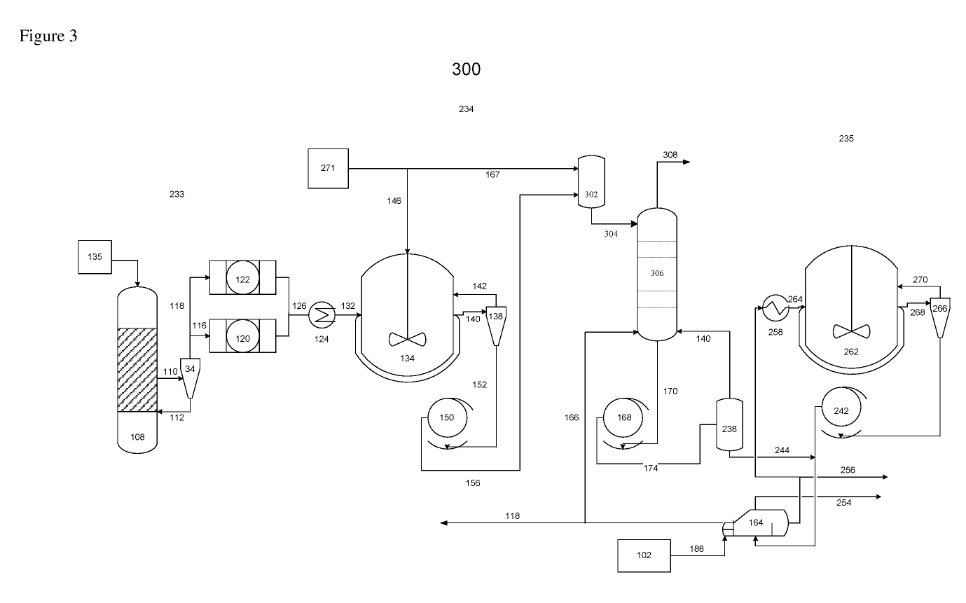

Another non-limiting embodiment of the invention is a variation of the embodiment described in FIG. 2 in which the second crystallizer is replaced by a reactive adsorption system. Referring to FIG. 3, the second crystallizer 154 described in FIG. 2 is replaced by a reactive adsorption system comprising a mixing tank 302 and a reactive adsorption column 306. The mixing tank 302 is connected to the ammonium source 271, the filter 150, and the reactive absorption column by conduits 167, 156, and 304, respectively. The reactive absorber is connected to the boiler 164 by conduit 166, to the flash tank 238 by conduit 140 and to the rotary filter 168 by conduit 170. The unabsorbed gas passes through conduit 308 to suitable post treatment or directly to the atmosphere.

The reactive adsorption system provides a countercurrent arrangement for the adsorption of carbon dioxide and the precipitation of metal carbonates. This allows for greater overall adsorption of the gas and increases vapor liquid contact.

As is appreciated, the invention is not limited to the piping arrangement and any pipe arrangement can be used to practice the invention. Further, the purge streams and vents can be located at any point within the system or on components, e.g., and not limiting to the invention, the crystallizers to allow for gas(es) inert to the chemical reactions to be released. Still further, process steam generated by the system can be used to operate the components of the sequestration system 100 and 230 or to operate other systems.

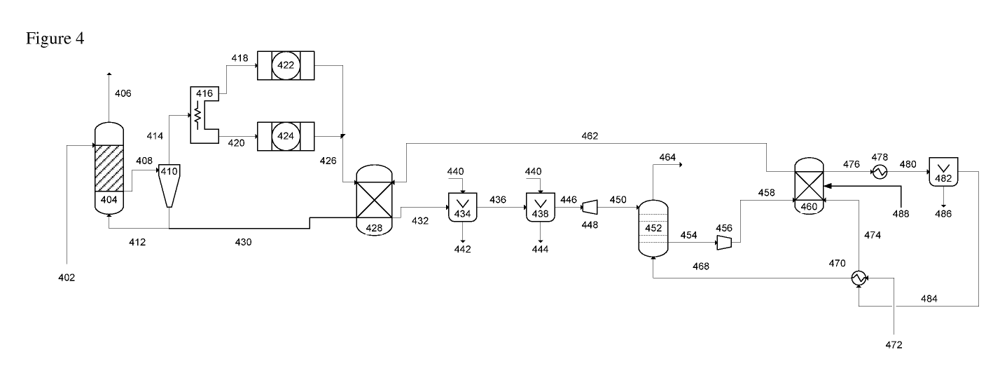

Another embodiment of the sequestration system and process for sequestering carbon dioxide using effluent streams is illustrated in FIG. 4. The sequestration system and processes described in this embodiment are similar to those described above with the following modifications. A digestion reactor 404 is fed with mineral and makeup acid in stream 402. Two outlets (406, 408) lead from the reactor 404. Outlet 406 removes water vapor formed in the digestion reactor 404. The mineral acid solution digestion reaction is suitably operated near or at the boiling point of the mineral acid solution. Heat is suitably supplied by the exothermic reaction of the digestion of the mineral, by heat from a suitable external source, or both. Suitable sources of external heating include heat from the effluent stream (e.g., hot flue gasses), steam heating, electric heating, gas fired heating, solar heating, and the like. The hydro-cyclone 410 is used to separate particulates in the mineral acid solution generated in reactor 404 into fines and large particles. The fines consist mainly of silica solids which are the product of the digestion and are piped through 414 to a magnetic separator 416. The large particles are recycled to the reactor through 412. The magnetic material (mostly magnetite) travels to filter 422 through 418. The magnetic solids are removed from solution and isolated for sale or further processing. The non-magnetic material travels from the separator 416 to a filter 424 through 420. The solids are removed and the effluent is combined with the effluent from 422 in stream 426. At this point the solution is free from solids and laden with metal cations from the digestion. The metal cations are removed from stream 426 in banks of cation exchange columns 428. The cation exchange columns are suitably operated in a semi batch fashion, having a cation loading and discharge cycle. Several banks can be used in parallel so as to not interrupt the continuous flow operation. Protons are exchanged for the metal cations. Thus the acid is regenerated and sent back to the reactor 404 in stream 430.

The second loop of FIG. 4 includes the portion of the system equipment denoted by reference numerals between 428 and 460. The stream in conduit 462 contains an acid under elevated pressure. A suitable acid includes carbonic acid, although any of a variety of other acids, or combinations thereof, can be used. The acid is suitably under pressure in the range of from about 1 atm up to about 1000 atm, or in the range of from about 5 atm up to about 500 atm, or in the range of from about 10 atm up to about 250 atm, or in the range of from about 15 atm up to about 100 atm, or even in the range of from about 20 atm to about 50 atm, or even in the range or from about 25 atm to about 40 atm. In certain embodiments, a pressure of about 30 atm to about 35 atm is desired. The protons in solution are exchanged for metal cations in 428. The metal cations are carried to a crystallizer 434 through 432. Base, such as ammonium or sodium hydroxide, is added to 434 in stream 440. Other bases may be suitably used. The addition of base increases the pH to give rise to the precipitation of metal ions, such as iron, to precipitate as metal carbonates. If serpentine is used as a starting material, the precipitant is iron carbonate. The solids are removed in stream 442. The solution is passed to a second crystallizer 438 via conduit 436 where the pH is raised again with additional base. At this point, magnesium carbonate precipitates if magnesium is in the parent material. Various metals present in the digestion solution can be individually precipitated at differing pH conditions as metal carbonates in multiple crystallizers. The remaining metal depleted solution is transported via conduit 446 to a hydro turbine 448 where it is brought to atmospheric pressure. At this point the solution is laden with the base added in stream 440. The solution is transported via conduit 450 to a absorber 452. Flue gas enters the system through conduit 472 and is cooled in heat exchanger 470. The cooled flue gas enters the absorber 452 through conduit 468. The high pH solution in conduit 450 is contacted with the flue gas within absorber 452, in which at least a portion of the carbon dioxide dissolves readily into solution. The remaining undissolved portion of the flue gas exits the absorber 452 through conduit 464. The solution is transported to a high pressure pump 456 through conduit 454 where it is re-pressurized. The solution is then passed to a second bank of ion exchange columns 460 through conduit 458. The cations from the base supplied to the system by conduit 440 are exchanged for protons within the ion exchange columns 460, which gives rise to the regeneration of the high pressure acid stream in conduit 462.

The third loop of FIG. 4 includes ion exchange columns 460, heat exchangers 470 and 478, and the crystallizer 482. Strong, saturated, cool acid/salt solution via conduit 484 is heated in 470. It is then passed to the ion exchange columns 460 through conduit 474. The hot solution extracts the cations such that a saturated or nearly saturated solution is produced. The solution is then transported via conduit 476 to a heat exchanger 478 where it is cooled to a temperature below the saturation point of the salt. The solution is passed to the crystallizer 482 through conduit 480. The salt precipitates and the strong, cool saturated acid salt solution is regenerated. The precipitated salt solids are removed through conduit 486. Makeup acid is added through conduit 488 at the end of the regeneration cycle to further remove cations and restore the acid that was consumed in the precipitation.

### EXAMPLES

### Investigation of the Digestion of Serpentine with Internal Grinding

The following are non-limiting examples that are representative only and that do not necessarily restrict the scope of the present invention.

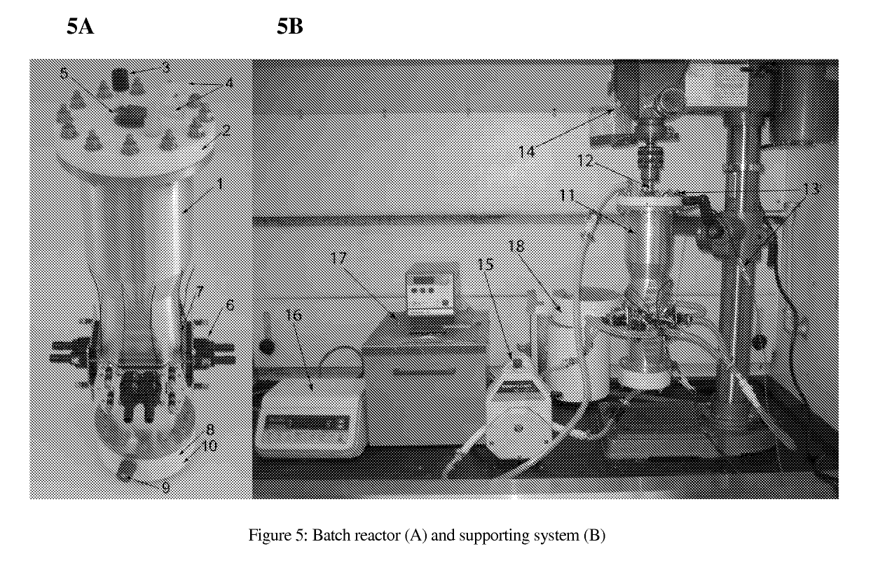

Experimental Sequestration system. A batch reaction system was constructed and is shown in FIG. 5. The system contained a reactor (1) that was milled from aluminum. The aluminum reactor body consisted of a tube with a three-inch (75 mm) bore that flares to four-inch (100 mm) bore and top and bottom flanges. The inside of the reactor is coated with a high-density, highly-cross-linked epoxy composite that provides extreme corrosion and abrasion resistance. The top of the reactor is capped by a poly(tetrafluoroethylene) (PTFE) flange (2) that is fitted with a thermocouple inlet (3), two through ports (4), and a charging port (5). The lower section has four flat faces milled in it to which four heat exchangers (6) and four thermoelectric modules (7) are attached. The bottom flange is capped by two PTFE flange attachments: a dispersion plate (8) with a sampling port on the side (9), and an inlet plate (10). The dispersion plate consisted of a circular array of 1 mm through holes that provide fluid dispersion or retainment of grinding media depending on the flow direction. The sampling port is embedded in the dispersion plate and allows direct access to the reactor contents through a septum. The bottom plate is a solid flange cap with an inlet tapped into the center. The reactor (11) is mounted in a 16 speed drill press (14). The drill press is used to provide agitation to the reactor bed via a tree type agitator (12). The temperature is monitored by a thermocouple (13) and logged on a computer (not shown). Heat is added and removed by thermoelectric modules (7) and controlled using a temperature controller (not shown) to achieve a temperature variance within 0.1° C. of the set point. The thermoelectric modules are capable of moving a maximum of 480 W of heat into or out of the fluid supplied by a circulated thermal bath (17). The temperature is kept uniform and the slurry well mixed by the agitation and a variable speed circulation pump (15) which is controlled by a motor controller (16). The pump is capable of circulating fluid from the bottom to the top of the reactor or vice versa. Insulation (18) can be added to the reactor to improve temperature stability.

During operation, the fluid bath is first brought to the temperature of interest and the acid and grinding media is charged to the reactor. The agitation is started and the reactor heating system is activated. The system is allowed to equilibrate and the mineral is brought to temperature by heating it in a beaker. When the temperature of the system is stable, a sample of acid is taken from the reactor to be analyzed for pH and composition as a starting point. The mineral is charged to the reactor and the time recorded.

Experimental Procedure. Optimum agitation speed, grinding media size, and grinding media loading are determined by conducting several experiments in which several process parameters are varied independently while measuring the amount of magnesium in solution at a set time. This step ensures that maximum particle surface refreshment is obtained. On regular time intervals, samples are drawn from the reactor and immediately filtered to remove all solids and quench the reaction. The samples are analyzed for chemical composition. Of particular interest is the magnesium and proton concentration in the solution. The composition can be determined by inductively coupled plasma spectroscopy or high pressure liquid ion chromatography. This information can be used to determine conversion and the activity of the protons in solution. Without being bound by any particular theory of operation, the activity and pH do not appear to directly correlate with the concentration of the protons as consequence of the strong ionic solution. Accordingly, an accurate model for ionic solutions, such as Pitzer, can be used to determine the activity of theprotons in solution. PHREEQC, a software program that uses the Pitzer equations, can be used to determine the proton activity within the solution based on the compositions of the samples. The PHREEQC program can be downloaded from the Internet at http://wwwbrr.cr.usgs.gov/projects/GWC_coupled/phreeqc/.

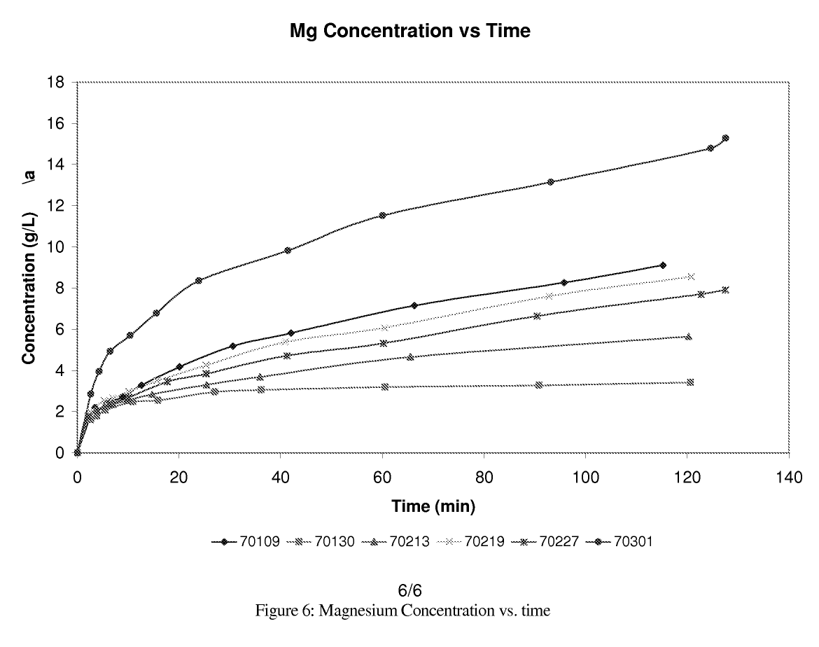

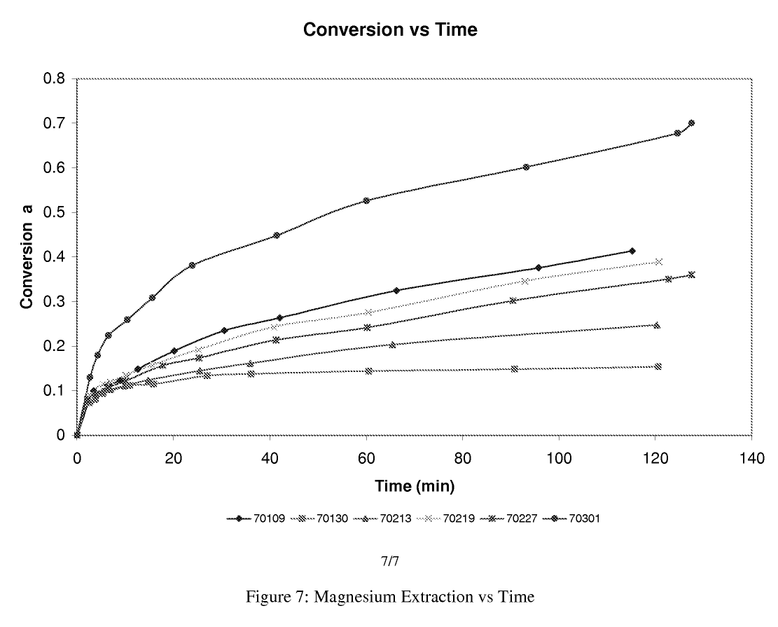

Results. Table 1 is a summary of the experimental conditions for the experimental serpentine digestion tests reported in FIGS. 6 and 7. Sample 70109 was used as an experimental basis. The weak acid system proposed by Park, et al., (Park, A. H. A. and L. S. Fan, “CO₂ Mineral Sequestration: Physically Activated Dissolution of Serpentine and pH Swing Process,” Chemical Engineering Science, 2004, 59(22-23): pp. 5241-5247) was tested in 70130. This was compared to a 1M sulfuric acid base case, which evidenced an extraction nearly 3 times higher than 70130. 70213 was a blank without any grinding media. Mild grinding with an agitator speed of 470 RPM nearly doubled the extracted magnesium. 70219 was run with double the agitation speed. Without being bound by any particular theory of operation, the extraction with double agitation speed was slightly less than the base case for the reason that the higher agitation speed effectively separated or fluidized the grinding media, resulting in a reduced collision frequency. It is also suspected that magnetite could cause passivating layers to form on the serpentine particles and slow the digestion. Therefore, high intensity magnets were used to separate magnetite from serpentine and the resulting iron free serpentine was digested in 70227. Passivating iron layers apparently did not to hinder the digestion. Rather, it seems that the iron may aid in the magnesium extraction. 70301 was run to test the limits of the system. When strong acid, small particle size, and higher temperatures were used, the magnesium extraction was nearly doubled. After about 120 minutes, Experimental Run No. 70301 (5M Sulfuric Acid, see Table 1 for additional conditions) resulted in a nearly 500% increase in Mg concentration (FIG. 6) and Mg conversion (FIG. 7) compared to digestion at the comparative conditions of Expermental Run No. 70130.

TABLE 1
Summary of Experimental Conditions

| | | | Initial | | | Grinding | | |
|---|---|---|---|---|---|---|---|---|
| | | Initial | Particle | | Agitator | Media | Pump | |
| Exp. Run | Acid | Conc | Size | Temp | Speed | Type | Flow | Direction |
| 70109 | Sulfuric | 1 Molar | 90 μm | 50° C. | 470 RPM | 3 mm | 2.00 LPM | Bottom |
| | Acid | | | | | Silica | | to Top |
| 70130 | Ortho- | 1 vol %, | 90 μm | 50° C. | 470 RPM | 3 mm | 2.00 LPM | Bottom |
| (Comp.) | phosphoric | 0.9 wt %, | | | | Silica | | to Top |
| | Acid, | 0.1 wt % | | | | | | |
| | Oxalic | | | | | | | |
| | Acid, | | | | | | | |
| | EDTA | | | | | | | |
| 70213 | Sulfuric | 1 Molar | 90 μm | 50° C. | 470 RPM | None | 2.00 LPM | Bottom |
| | Acid | | | | | | | to Top |
| 70219 | Sulfuric | 1 Molar | 90 μm | 50° C. | 813 RPM | 3 mm | 2.00 LPM | Bottom |
| | Acid | | | | | Silica | | to Top |
| 70227 | Sulfuric | 1 Molar | 90 μm | 50° C. | 470 RPM | 3 mm | 2.00 LPM | Bottom |
| | Acid | | No Iron | | | Silica | | to Top |
| 70301 | Sulfuric | 5 Molar | 38 μm | 75° C. | 813 RPM | 2 mm | 4.00 LPM | Top to |
| | Acid | | | | | Silica | | Bottom |

Based on the description of the embodiments of the invention, it can be appreciated that this invention is not limited to the particular embodiments disclosed but it is intended to cover modifications that are within the spirit and scope of the invention.

What is claimed:

1. A method for sequestering carbon dioxide from a carbon dioxide-generating source, comprising:
dissolving at least a portion of a mineral with an acid, the mineral comprising a metal or cations thereof, to provide an acidic mineral solution comprising metal cations and protons;
contacting at least a portion of the metal cations with a base to give rise to a metal-containing solid precipitant and a supernatant;
contacting flue gas from the carbon dioxide-generating source to at least a portion of the metal cations, or to at least a portion of the supernatant, or both, wherein the flue gas comprises carbon dioxide; and
recovering base from the supernatant using, wherein heat is utilized in recovering the base from the supernatant.

2. The method according to claim 1, wherein the acid and concentration of the acid in the acidic mineral solution is selected so as to ensure that the pH of the acidic mineral solution is less than 4.

3. The method according to claim 1, wherein the acid comprises, hydrochloric acid, sulfuric acid, nitric acid, carbonic acid, perchloric acid, chloric acid, hypochloric acid, acetic acid, phosphoric acid, or any combination thereof.

4. The method according to claim 1, wherein the mineral is dissolved at a temperature in the range of from about 25° C. to about 200° C.

5. The method according to claim 1, wherein the mineral is dissolved at a temperature in excess of the normal boiling point of the acid and at a pressure greater than 1 atm.

6. The method according to claim 1, wherein the mineral is dissolved using autogenous grinding, non-autogenous grinding, no grinding, or any combination thereof.

7. The method according to claim 1, wherein the metal ions and base are contacted in one or more crystallizers, one or more reactive adsorption columns, or both.

8. The method according to claim 1, further comprising removing undissolvable solids from the acidic mineral solution.

9. The method according to claim 1, wherein the flue gas and metal ions are contacted by bubbling the flue gas into the solution comprising the metal cations, using a bubble tray tower, using a packed column, using a sparger, spraying the solution as a mist in a gaseous stream comprising the flue gas, using a stripper, adapting a scrubber system, using a gas absorption column, or any combination thereof.

10. A precipitant made according to the method of claim 1.

11. The precipitant made according to claim 10, wherein the precipitant comprises a solid oxide, hydroxide or salt of iron, magnesium, calcium, copper, manganese, chromium, sodium, or any combination thereof.

12. The method of claim 1, wherein two or more different metal salts are precipitated.

13. The method of claim 1, wherein the metal salts include iron hydroxide and magnesium carbonate.

14. The method of claim 1, wherein the metal salts are substantially pure.

15. The method according to claim 1, wherein the carbon dioxide generating source includes a hydrocarbon-fueled power system, a hydrocarbon-fueled engine for producing useful work, a chemical process system, a heating system, a cement kiln, a synthetic fuels generation system, or any combination thereof.

16. The method according to claim 1, wherein the mineral is dissolved by contacting the mineral with the acid in a reactor under autogenous grinding conditions, semiautogenous grinding conditions, non-grinding conditions, or any combination thereof.

17. The method according to claim 16, wherein grinding media is used to aid the dissolution of the mineral.

18. The method according to claim 17, wherein grinding media includes glass beads, silicon carbide beads, ceramic beads, steel beads, coated steel beads, or any combination thereof.

19. The method according to claim 1, wherein the mineral includes olivine, serpentine, antigorite, basaltic formations, brucite, lizardite, cement, asbestos, or any combination thereof.

20. The method according to claim 1, wherein the metal includes iron, magnesium, calcium, copper, manganese, chromium, sodium, or combination thereof.

21. The method according to claim 1, wherein the metal cations include Fe+2, Fe+3, Mg+2, Mn+2, Cr+2, Cr+3, Na+, Zn+2, Al+3 or any combination thereof.

22. The method according to claim 1, wherein the acid mineral solution and the base are mixed in a first crystallizer to give rise to the metal-containing solid precipitant and a first supernatant.

23. The method according to claim 22, wherein the pH of the contents in the first crystallizer is in the range of from about 5 to about 14.

24. The method according to claim 22, wherein the first supernatant and a base are mixed in a second crystallizer with the flue gas to give rise to a second metal-containing solid precipitant and a second supernatant.

25. The method according to claim 24, wherein the pH of the contents in the second crystallizer is in the range of from about 6 to about 14.

26. The method according to claim 22, wherein the first supernatant and a base are mixed in an adsorption column or a reactive adsorption column with the flue gas to give rise to a second metal-containing solid precipitant and a second supernatant.

27. The method according to claim 22, further comprising exchanging positive metal ions with protons using a high pressure acid recycle loop in fluidic communication with ion exchange media.

28. The method according to claim 1, wherein the base includes ammonium hydroxide, sodium hydroxide, calcium hydroxide, potassium hydroxide, magnesium hydroxide, or any combination thereof.

29. The method according to claim 1, wherein the base is removed from the supernatant using an ammonium-based refrigeration system, an ion-exchange system, a crystallizer, one or more ion exchange membranes, a solar pond, an evaporative cooling tower, or any combination thereof.

30. The method according to claim 1, wherein the flue gas is fluidically communicated into one or more of the following process units: a heat exchanger, a conduit for fluidically delivering the flue gas to a crystallizer, a reactive absorber, an absorber, a stripping column, a vapor-liquid continuously stirred tank reactor, a vapor-liquid plug flow reactor, vapor-liquid batch reactor, or a vapor-liquid semi-batch reactor.

31. A method for producing one or more substantially pure metal salts from a mineral, comprising:
dissolving at least a portion of a mineral with an acid, the mineral comprising a metal or cations thereof, to provide an acidic mineral solution comprising metal cations and protons;
contacting at least a portion of the metal cations with a base to give rise to a metal salt-containing solid precipitant and a supernatant;
recovering base from the supernatant, wherein heat is utilized in recovering the base from the supernatant; and
contacting flue gas from a carbon dioxide-generating source to at least a portion of the metal cations, or to at least a portion of the supernatant, or both, wherein the flue gas comprises carbon dioxide.

32. A substantially pure metal salt produced according to the method of claim 31.

33. A substantially pure metal salt produced according to the method of claim 31, wherein the metal salt has a purity of greater than about 98 percent based on weight.

34. A sequestration system for sequestering carbon dioxide from a carbon dioxide-generating source, comprising:
a mineral dissolving system for dissolving at least a portion of a mineral with an acid, wherein the mineral comprises metal or cations thereof, the mineral dissolving system capable of providing an acidic mineral solution comprising metal cations and protons;
a metal salt precipitation system for contacting metal cations received from the mineral dissolving system with base to give rise to a metal salt-containing solid precipitant and a supernatant;
a base management system for feeding base into the metal salt precipitation system and for recovering base from the supernatant; and
a flue gas management system capable of:
receiving flue gas comprising carbon dioxide from the carbon dioxide-generating source;
contacting at least a portion of the flue gas to at least a portion of the metal cations, or to at least a portion of the supernatant, or both; and
utilizing heat for recovering at least a portion of the base from the supernatant in the base management system.

35. The sequestration system according to claim 34, wherein the carbon dioxide generating source includes a hydrocarbon-fueled power plant, a hydrocarbon-fueled engine for producing useful work, a chemical process factory, a heating system, a cement kiln, a synthetic fuels plant, or any combination thereof.

36. The sequestration system according to claim 34, wherein the mineral dissolving system includes a reactor capable of contacting the mineral with the acid under autogenous grinding conditions, semiautogenous grinding conditions, non-grinding conditions, or any combination thereof.

37. The sequestration system according to claim 36, wherein the reactor includes grinding media.

38. The sequestration system according to claim 34, wherein the minerals include olivine, serpentine, antigorite, basaltic formations, brucite, lizardite, cement or any combination thereof.

39. The sequestration system according to claim 34, wherein the metal salt precipitation system comprises a crystallizer capable of receiving acid mineral solution directly or indirectly from the mineral dissolving system, wherein the crystallizer is further capable of receiving the base to give rise to the metal-containing solid precipitant and a supernatant.

40. The sequestration system according to claim 39, wherein the metal salt precipitation system further comprises a second crystallizer capable of receiving acid mineral solution directly or indirectly from the supernatant arising from the first crystallizer, wherein the second crystallizer is further capable of receiving a base and at least a portion of the flue gas to give rise to a second metal-containing solid precipitant and a supernatant.

41. The sequestration system according to claim 39, wherein the metal salt precipitation system further comprises a reactive adsorption column capable of receiving acid mineral solution directly or indirectly from the supernatant arising from the first crystallizer, wherein the reactive adsorption column is further capable of receiving a base and at least a portion of the flue gas to give rise to a second metal-containing solid precipitant and a supernatant.

42. The sequestration system according to claim 39, wherein the metal salt precipitation system further comprises a high pressure acid recycle loop in fluidic communication with ion exchange media capable of exchanging positive metal ions with protons.

43. The sequestration system according to claim 34, wherein the base management system comprises an ammonium-based refrigeration system, an ion-exchange system, a crystallizer, one or more ion exchange membranes, or any combination thereof.

44. The sequestration system according to claim 34, wherein the devices for recovering base from the supernatant comprises an ammonium-based refrigeration system, an ion-exchange system, a crystallizer, a solar pond, an evaporative cooling tower, or any combination thereof.

45. The sequestration system according to claim 34, wherein the flue gas management system comprises a heat exchanger, a conduit for fluidically delivering the flue gas to a crystallizer, a reactive absorber, an absorber, a stripping column, a vapor-liquid continuously stirred tank reactor, a vapor-liquid plug flow reactor, vapor-liquid batch reactor, a vapor-liquid semi-batch reactor, or any combination thereof.
